(19) United States
(12) Patent Application Publication
(10) Pub. No.: US 2016/0004276 A1
(43) Pub. Date: Jan. 7, 2016

(54) WEARABLE COMPUTER WITH TIME INDICATIONS AND MOVEMENTS

(71) Applicant: Christian Stroetmann, Moers (DE)

(72) Inventor: Christian Stroetmann, Moers (DE)

(21) Appl. No.: 14/791,854

(22) Filed: Jul. 6, 2015

(30) Foreign Application Priority Data
Jul. 7, 2014 (DE) 20-2014-005-491.6

(51) Int. Cl. G06F 1/16; H02J 7/02

(52) U.S. Cl. CPC G06F 1/163; G06F 1/1698; G06F 1/1694; H02J 7/025

(57) ABSTRACT

Embodiments of a wearable computer are disclosed. The wearable computer comprises an electronic module, a display device, at least one rechargeable electrical energy storage device, a housing containing the display device and the electronic module, and at least one additional visual time indication built into the housing area surrounding the display device at the frontside. In some embodiments, the wearable computer can have a means for wirelessly charging the energy storage device, and a strap or band mounted on the housing. This permits the wearable computer to provide a long runtime and to assume novel configurations.

### CROSS-REFERENCE TO RELATED APPLICATION

This application claims the benefit of the German Utility Model Application No. 20-2014-005-491.6, filed Jul. 7, 2014, and entitled “Mobiles Computersystem, das eine Vorrichtung zur optischen, mehrfarbigen Signalisierung von veränderlichen Informationen, eine Stromversorgung and ein Computergehäuse besitzt”, which is hereby incorporated by reference in its entirety.

### BACKGROUND

1. Field of the Disclosure

The present application relates generally to portable information processing devices worn on a body part of a user. More particularly, the present invention pertains to housings or cases containing an electronic module, a display device, and at least one visual time indication means, that is integrated in the area, which frames the display device at the frontside of the housing and indicates the time even when the electronic module and the display device are not running.

2. Description of the Related Art

Portable electronic devices are commonplace today. Some examples of portable electronic devices include portable digital assistants, portable media players, radio receivers, pagers, mobile telephones, and portable game consoles.

Some of these portable electronic devices are suitable on the one hand to be mounted respectively worn on a body part of a user, such as the wrist, arm, head, shoulder, and hip for example, and on the other hand to process arbritary informations and to execute arbritary programs stored in the memory. Such body-worn information processing devices respectively wearable computers are available in various types, such as a wrist watch respectively smart watch, a pair of glasses and goggles respectively smart eyewear and optical head-mounted display, and a belt respectively smart belt to give some few examples.

These body-worn computing devices contain, in addition to the essential components as for example a wrist watch, a pair of glasses and goggles, and a belt, a variety of electronic circuits, such as a variety of user interfaces for providing ways of operation by a user or/and a variety of sensors for measuring a surrounding environment, a processor for performing general and special information processing, a memory function for storing programs and input data from the outside, a display for presenting changeable visual informations, and so on to provide a variety of additional functions others than a time display function, an eye protection function, or just an aesthetic function.

As one consequence of the increased functionalities, performances, and demands of a user, the need for electric power to run wearable computers increased as well, which makes it inevitable for such devices to supply larger electric energy sources respectively batteries due to the limited energy density of a battery. But this does not solve the problem and therefore either as much as possible of the additional electronic components are switched off as often as possible to save energy and in this way even the functions of the essential components are switched of as well, or essential components are combined with additional electronic components leading to other disadvantageous consequences.

In U.S. Pat. No. 5,889,737, issued Mar. 30, 1999, and entitiled “Wrist carried electronic device”, a device is disclosed that may be a watch or may be adapted for personal communication or personal computing, and includes a conventional watch face. Alternatively, if the device incorporates a pager, there might be a small liquid crystal display. In U.S. Pat. No. 6,158,884, issued, and entitiled “Integrated communicative watch”, further embodiments of the device disclosed in the former patent are also disclosed that include a slide-out display device, housed within the device's electronic unit when not in use, or one or more hingedly attached displays. The display devices are disclosed as being any of a liquid crystal display, a light emitting display, an electroluminescent display, or any other similar type of display device well known in the art through which information may be viewed by the user as a direct view image and/or miniature virtual image, dependent upon the type of the integrated display.

The problem with these two inventions is that on the one hand the visible area at the frontside of the wrist-worn device is split into an area with a watch face and timing mechanism, and an area with a digital display, which reduces precious space for the display device, and that on the other hand the one display device has to be explicitly slid out and the other one or more display devices have to be rotated or folded up to become viewable, which is uncomfortable and might be unaesthetic for a user.

In U.S. Pat. No. 6,590,835, issued Jul. 8, 2003, and entitiled “Portable object with a wristband including a keyboard”, an electronic wristwatch of the analogue type is disclosed, which includes a metal case housing in particular a time-keeping circuit and a stepping motor combined with a gear train for driving hands indicating the time, and a conventional liquid crystal display device of the dot-matrix type forming the dial of the time display by hands.

The problem with this invention is that the mechanical time indication affects the use of the display device, because the time indication overlays the information displayed on the electronic display all the time.

Similar approaches overlay a watch face and mechanical time indication with a transparent electronic display device, which also functions as the watch glass. The problem with such a solution is that neither truly transparent, electric power efficient display devices, nor transparent display devices, which provide a high quality of brightness, are available at this time.

Another approach of integrating an analogue time-keeping device and an electronic display device are wristwatches that have a wearable computer mounted on the wristband or the clasp of the wristband, which is uncomfortable to use and might be unaesthetic for a user as well.

However, it becomes appearent that many problems and also details of the proposed solutions with respect to the primary functions and the additional functions, the design limits, and further aspects of the related housings have not been addressed completely for these types of wrist-worn electronic devices in particular and for similar body-worn information processing devices respectively wearable computers in general. Furthermore, continuing demands and needs to improve ergonomics and aesthetics of body-worn electronic devices have not been completely solved.

Accordingly, the present invention is directed to the housings as well as the arrangements of time indications contained within the housing, which are suitable for a wearable computer and substantially obviate one or more of the problems due to imperfections, limitations, and disadvantages of the related art, and do not adversely affect the aesthetic appearance.

### BRIEF SUMMARY

In accordance with the purpose of the invention, as embodied and broadly described, the invention pertains to a body-worn information processing device respectively wearable computer that comprises a housing or case, an electronic module including at least one processor and at least one data memory, and a main display arranged within the housing, at least one battery, at least one visual time indication means, and an optional strap or band mounted on the housing.

Several embodiments of the present invention provide different types of the visual time indication means comprising moving mechanical indications, electronic indications, electromechanical indications, and active and passive electronic displays.

Other embodiments comprise a separate clock having a movement respectively module, which is arranged within the housing and uses at least one time indication of the wearable computer. The movement respectively module of the separate clock can include different types, such as a mechanical movement, an electronic movement or electronic module, an electromechanical movement or electromechanical module, a movement or module with an electronic quartz oscillator as clock generator, and a movement or module with a linear encoder. In addition, an optional electric energy storage device can provide the separate clock with electric power, so that it functions without the whole wearable computer running. This option is specifically advantageous with wearable computers that must provide at least a time function, such as a smartwatch or computer for divers and pilots for example.

In further embodiments the wearable computer can have a housing with one or more touch-sensitive sensors, and one or more contactless sensors for tracking the movement of the wearable computer, capturing information about the surrounding environment, and capturing visual and acoustical information. The wearable computer can also have a wireless charging module and a wireless communication interface to other electroinc devices.

Through the combination of the different visual time indication means with each other and with the different clock movements respectively modules many different variants of the wearable computer can be constructed.

The invention may be implemented in numerous ways. Exemplary preferred embodiments of the present invention are wrist-worn electronic information processing devices with a display respectively smartwatches, that are discussed below, but not limited to such portable electronic devices and in this way applies to for example body belts, and also shoulder-worn or leg-worn wearable computers as well. In this conjunction, all the electronic components or units, time-keeping devices, and time indication means, which form the various parts of said smartwatches and which are known to those skilled in the art in the field of computer engineering, common machine engineering, and watchmaking, will not be described in detail. Only said components and parts necessary to the elaboration of preferred embodiments of wearable computers according to the invention will be described.

Other systems, methods, features, advantages, objects, and further areas of applicability together with a more complete understanding of the disclosure will be, or will become, apparent and appreciated to one with skill in the art upon examination of the following figures and detailed description, or may be learned by practice of the present invention. It is intended that all such additional systems, methods, features, and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed, but are not intended to limit the scope of the disclosure.

### BRIEF DESCRIPTION OF THE DRAWINGS

Various embodiments in accordance with the present disclosure will be described with reference to the drawings, in which:

FIG. 1 illustrates a plan view of a wearable computer according to a first embodiment;

FIG. 2 illustrates a plan view of a wearable computer according to a second embodiment;

FIG. 3 illustrates a plan view of a wearable computer according to a third embodiment;

FIG. 4 illustrates a plan view of a wearable computer according to a fourth embodiment;

FIG. 5 illustrates a plan view of a wearable computer according to a fifth embodiment; and

FIG. 6 illustrates a plan view of a wearable computer according to a sixth embodiment.

### DETAILED DESCRIPTION OF THE INVENTION

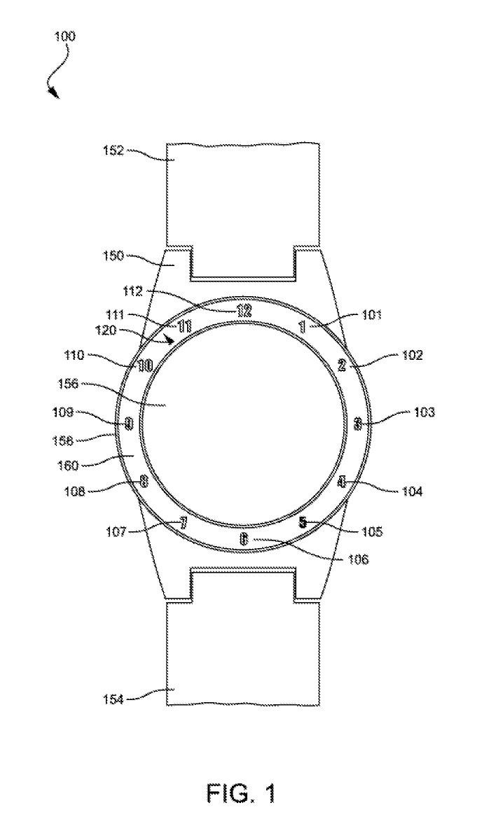

FIG. 1 schematically illustrates a first preferred embodiment of a wearable computing device 100. The wearable computer 100 comprises a housing 150, a first strap portion 152, a second strap portion 154, a main display device 156, a bezel 158, and a second electronic display device 160 formed as a ring, integrated into the bezel, and configured as an electronic time indication, as described hereinafter. An electronic module and the main display device are arranged within the housing and an electric energy storage can be arranged within the housing, in one or both strap portions 152, 154, or in the housing and the strap.

The bezel display device 160 displays image elements 101 to 112 as hour marks and the image element 120 as a virtual minute hand. In this example, the hour mark 105 is displayed in a different way than the other hour marks indicating “5 hours” and the virtual minute hand 120 is displayed at a position indicating “53 minutes”, so the displayed time is “5:53”.

Although only the image elements 101 to 112 and 120 are illustrated in this example, it should be understood that within the scope of the various embodiments there can be additional or alternative image elements of the same or a different type displayed at various other locations on the bezel display device 160, such as image elements having the same or a different color and image elements being static or animated. In addition, the main display device 156 and the bezel display device 160 can display information having an optical or/and a semantical relation.

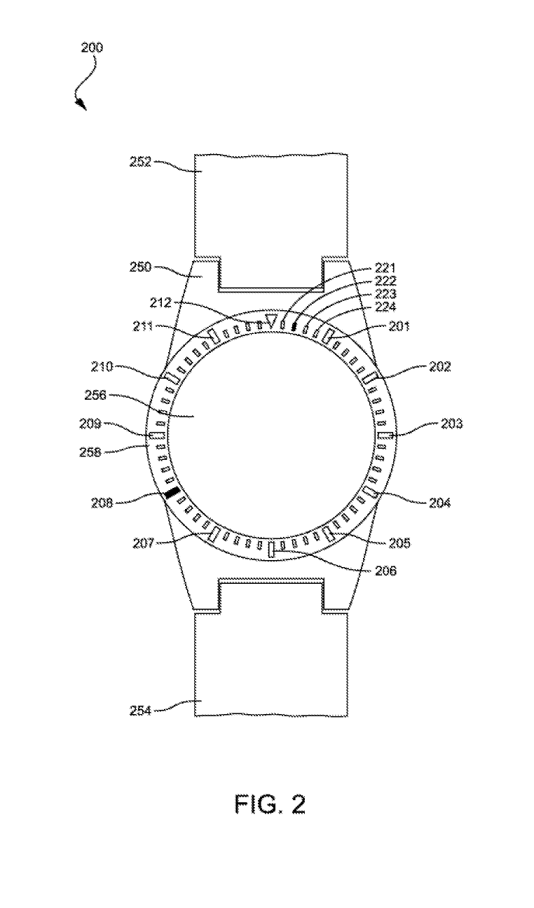

FIG. 2 schematically illustrates a second preferred embodiment of a wearable computing device 200. The wearable computer 200 comprises a housing 250, a first strap portion 252, a second strap portion 254, a main display device 256, a bezel 258, light emitting diodes 201 to 212 and 221 to 224 and also multiple unnumbered light emitting diodes arranged between light emitting diodes 201 to 212, which are integrated into the bezel and configured as an electronic time indication, as described hereinafter. An electronic module and the main display device are arranged within the housing and an electric energy storage can be arranged within the housing, in one or both strap portions 252, 254, or in the housing and the strap.

The light emitting diodes 201 to 212 are configured as hour marks, and between two adjacent hour marks four light emitting diodes are arranged, which are configured as minute marks. In the FIG. 2 only the minute marks 221, 222, 223, and 224 are numbered for better illustruation. In this example, the hour mark 208 is switched on for indicating “8 hours” and the minute mark 222 is switched on for indicating “2 minutes”, so the displayed time is “8:02”. If only one of the light emitting diode hour marks 201 to 212 is switched on, then the time is exactly the hour that the related light emitting diode is representing. For example, if only the hour mark 212 is switched on, then the displayed time is “12:00”.

In modifications of the embodiment shown in FIG. 2 the light emitting diodes can emit light in more than one color, which provides different ways of information codings, such as to use different colors for the indication of the two day periods ante meridiem or a.m. and post meridiem or p.m., or of the time at a distant location. Furthermore, the light emitting diodes 201 to 212 can be used to realize animations and various other functions, such as a stopwatch function and a count-down function, or a compass function for example. In addition, the light emitting diodes 201 to 212 can also be mounted on the bezel 258 as bezel riders for aesthetic reasons.

Moreover, the bezel 258 can also be mounted on the housing 250 in a turnable way, as it is common for a diver's watch and a chronograph with tachymeter for example, and thereby the wearable computer can provide additional modes of use and time keeping functions as well. Accordingly, the light emitting diode 212 has a triangular shape as it is also common for such watches to be readable and distinguishable in a better and easier way for a user wearing such a portable electronic device.

With a separate clock, which has a mechanical movement, an electronic movement or module, or an electromechanical movement or module, and an own electric energy storage the time keeping function can be provided even when the electric energy storage device supplying the electronic module of the wearable computer with electric power is discharged. Because the additional possibility for indicating the time in this way is very energy-saving, it can be operated over a number of years without recharge or exchange of the battery.

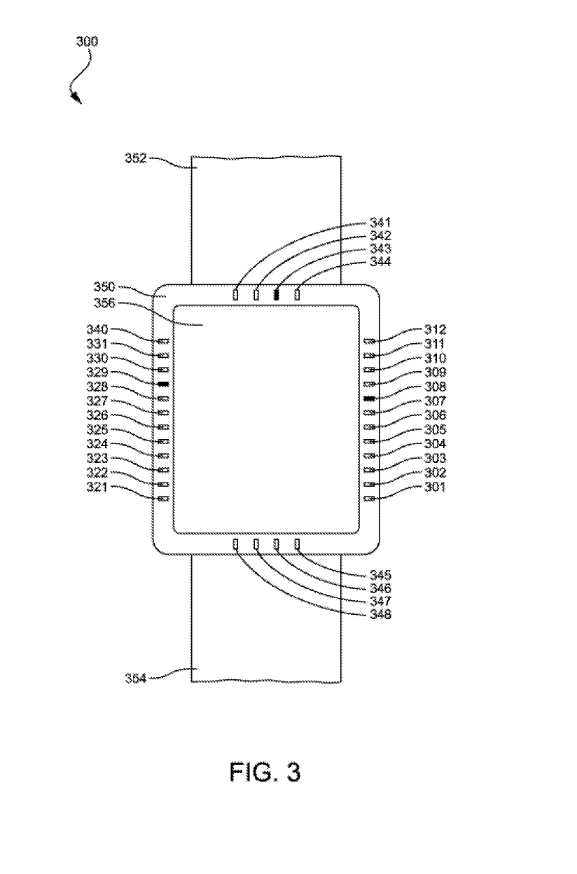

FIG. 3 schematically illustrates a third preferred embodiment of a wearable computing device 300. The wearable computer 300 comprises a housing 350, a first strap portion 352, a second strap portion 354, a main display device 356, light emitting diodes 301 to 312, 321 to 331, and 340 to 344, which are integrated into the edge of the housing and configured as an electronic time indication, and light emitting diodes 345 to 348, which are also integrated into the edge of the housing and configured as additional signal means, as described hereinafter. An electronic module and the main display device are arranged within the housing and an electric energy storage can be arranged within the housing, in one or both strap portions 352, 354, or in the housing and the strap.

In this embodiment, the time indication with the light emitting diodes 301 to 312, 321 to 331, and 340 to 344 is coded in an unconventional way. The light emitting diodes 301 to 312 are configured as hour marks, the light emitting diodes 321 to 331 are configured as marks for 5 to 55 minutes stepped by 5 minutes, the light emitting diodes 341 to 344 are configured as 1, 2, 3, or 4 minutes respectively, and the light emitting diode 340 is configured as an indicator for the two day periods ante meridiem or a.m. and post meridiem or p.m. The minutes marked by the light emitting diodes 321 to 331 and 341 to 344 have to be added to get the overall count of minutes. In this example, the light emitting diode 308 is switched on for indicating “8 hours”, the light emitting diode 329 is switched on for indicating “45 minutes”, the light emitting diode 343 is switched on for indicating “3 minutes”, and the light emitting diode 340 is switched off for indicating “a.m.”, so the displayed time is “8:45+3 a.m.” or “8:48 a.m.”.

The light emitting diodes 345 to 348 can be used for signaling arbitrary information, such as a stand-by mode of the electronic module of the wearable computer, an incoming message, or a discharged battery for example.

In modifications of the embodiment shown in FIG. 3 the light emitting diodes can emit light in more than one color, which provides different ways of information codings, such as to use different colors for the indication of the time at a distant location. Furthermore, the light emitting diodes can be used to realize animations and various other functions, such as a stopwatch function and a count-down function for example.

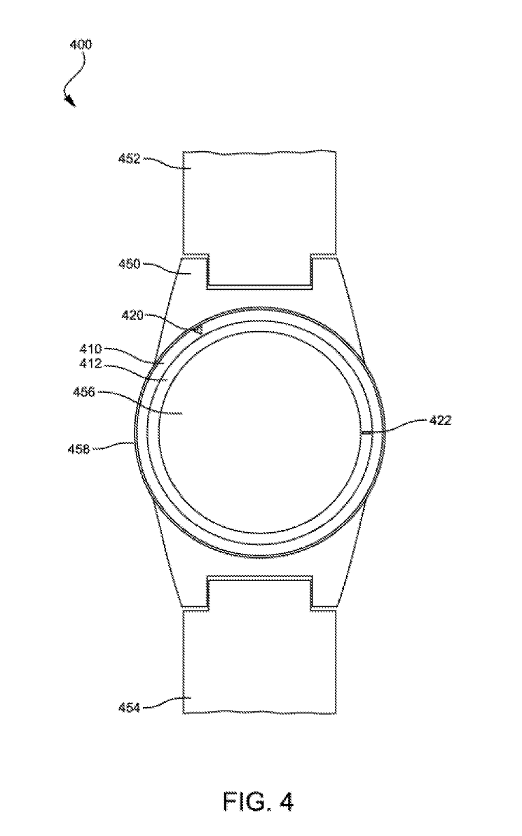

FIG. 4 schematically illustrates a fourth preferred embodiment of a wearable computing device 400. The wearable computer 400 comprises a housing 450, a first strap portion 452, a second strap portion 454, a main display device 456, a bezel 458, rings 410, 412 with members 420, 422 configured as time indication. An electronic module and the main display device are arranged within the housing and an electric energy storage can be arranged within the housing, in one or both strap portions 452, 454, or in the housing and the strap.

In this embodiment, the rings 410, 412 can be driven by a suitable mechanical movement or one or two electric stepper motors controlled by an electronic module not shown for better illustration. In addition, the time indicators 420, 422 can be marks printed on the rings, or light emitting diodes mounted on or integrated into the rings.

In this example, the member 420 on the ring 410 is configured as minute mark indicating “50 minutes” and the member 422 on the ring 412 is configured as hour mark indicating “3 hours”, so the displayed time is “3:50”.

In modifications of the embodiment shown in FIG. 4, a third ring can be added for indicating seconds, but this has the disadvantage that too much of the precious space for the main display device 456 might be wasted in this way. Furthermore, one or more rings can be used to realize various other functions, such as a stopwatch function and a count-down function, or a compass function for example. In addition, it should be possible for a person skilled in the art to substitute one or more rings with one or more belts or chains, which are driven in the same way as the rings. By using additional elements, such as guide pulleys for example, also devices that have no round main display device can be constructed with such a type of time indication.

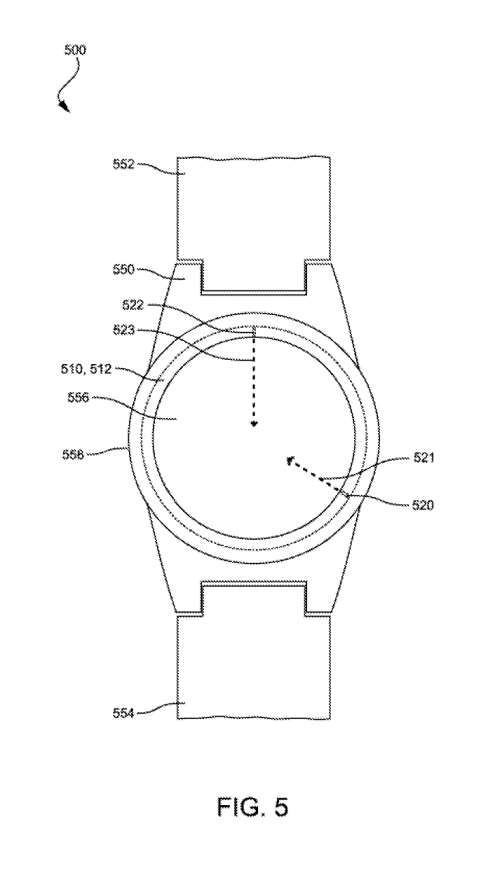

In FIG. 5 a fifth embodiment of a wearable computer 500 is schematically illustrated. The wearable computer 500 comprises a housing 550, a first strap portion 552, a second strap portion 554, a main display device 556, a bezel 558, rings 510, 512, and light emitting members 520, 522 configured as time indication. The ring 512 is arranged below the ring 510 and therefor ring 512 can not be seen in this illustration. An electronic module and the main display device are arranged within the housing and an electric energy storage can be arranged within the housing, in one or both strap portions 552, 554, or in the housing and the strap.

In this embodiment, the rings 510, 512 can be moved by a suitable mechanical movement or one or two electric stepper motors controlled by an electronic module, which are not shown for better illustration. The light emitting time indicators 520, 522 can be light emitting diodes or laser diodes, which are mounted on or integrated into the rings, and emit light beams 521, 523, which represent virtual time indicators.

In this example, the light beam 521 represents a virtual hour hand indicating “4 hours” and the light beam 523 represents a virtual minute hand indicating “0 minutes”, so the displayed is “4:00”.

In modifications of the embodiment shown in FIG. 5, a third ring can be added for indicating seconds, but this has the consequence that the wearable device becomes thicker in this way. Moreover, the light emitting members can emit light in more than one color, which provides different ways of information codings, such as to use different colors for the indication of the two day periods ante meridiem or a.m. and post meridiem or p.m., or of the time at a distant location. Furthermore, the light emitting members can be used to realize animations and various other functions, such as a stopwatch function and a count-down function, or a compass function for example.

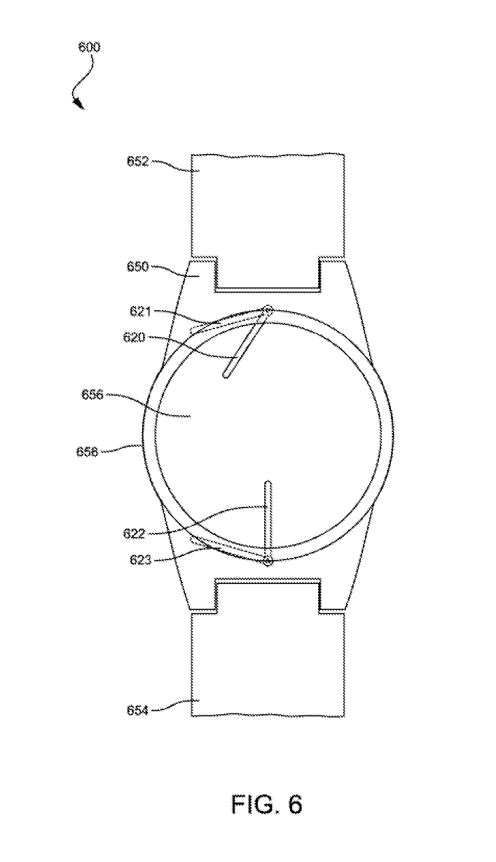

In FIG. 6 a sixth embodiment of a wearable computer 600 is schematically illustrated. The wearable computer 600 comprises a housing 650, a first strap portion 652, a second strap portion 654, a main display device 656, a bezel 658, and hands 620, 622 configured as time indication. An electronic module and the display device are arranged within the housing. The electric energy storage can be arranged within the housing, in one or both portions of the strap 656, 658, or in the housing and the strap.

In this embodiment, the hands 620, 622 can be driven by a suitable mechanical movement or one or two electric stepper motors controlled by an electronic module not shown for better illustration. For not affecting the use of the main display 656 the hand 620 can be retracted into for example the position 621 and the hand 622 can be retracted into for example the position 623 respectively. In addition, the time indicators 620, 622 can comprise one or more light emitting diodes mounted on or integrated into the hands, or be transparent members each illuminated by an integrated light emitting diode.

In this example, the time indicator 620 represents an hour hand indicating “8 hours” and the time indicator 622 represents a minute hand indicating “30 minutes”, so the displayed time is “8:30”.

In modifications of the embodiment shown in FIG. 6 the time indicators 620, 622 can be used to realize various other functions without or in combination with the main display 656, and the main display device can also form the dial of the time display with the time indicators.

In various embodiments illustrated in FIGS. 1 to 6 the disclosed wearable computer can include many types of display devices such as a touch screen, electronic paper (e-paper) display device, interferometric modulator display (IMOD) device, liquid crystal display (LCD) device, organic light emitting diode (OLED) display device, or quantum dot based light emitting diode (QLED) display device, while an electronic paper or another passive display device technology is preferable for an electric energy saving time indication, as in the case of the bezel display device 160 of the first embodiment shown in FIG. 1.

The specification and drawings are to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, in various embodiments of the invention the various types of the visual time indication means of a wearable computer discussed and suggested in FIGS. 1 to 6 can have fewer or additional elements of similar or alternative types in other embodiments, and can be combined with elements of the other types of visual time indication means. The scope of the present disclosure shall be determined only by the appended claims and their equivalents. In addition, variations and modifications in the component parts, arrangements, or/and alternative uses must be regarded as included in the appended claims.

1. A wearable computer comprising:
an electronic module including:
at least one processor for processing arbitrary informations,
at least one data memory for storing arbitrary data, and
at least one control circuitry being configured for performing predetermined functions of the wearable computer;
a display device;
at least one rechargeable electrical energy storage device for providing electric power to the display device, the electronic module, and other electronic components of the wearable computer;
a housing containing said display device and said electronic module therein; and
at least one visual time indication means,
wherein said one or more visual time indication means are built into the housing area surrounding the display device at the frontside.

2. The wearable computer according to claim 1, further comprising:
at least one electric stepper motor for moving at least one visual time indication means.

3. The wearable computer according to claim 1,
wherein at least one visual time indication means includes one of (a) a moving mechanical indication, such as (b) a moving hand, (c) a rotating ring, (d) a moving belt, and (e) a moving chain, (f) an electronic indication, such as (g) a light-emitting diode, and (h) a laser diode, an (i) electromechanical indication, or (j) an electronic display, such as (k) a liquid crystal display, (l) an light-emitting diode display, (m) a laser projector (n), an e-paper display, and (o) an interferometrically working modulator display.

4. The wearable computer according to claim 3,
wherein at least one electromechanical time indication means comprises:
at least one moving mechanical time indication means; and
at least one electronic time indication means;
wherein said at least one electronic time indication means is mounted on said at least one mechanical time indication means for being moved.

5. The wearable computer according to claim 1, further comprising:
a separate clock having a movement,
wherein said separate clock is arranged within the housing and uses at least one visual time indication means of the wearable computer.

6. The wearable computer according to claim 5,
wherein the movement of the separate clock includes one of (a) a mechanical movement, (b) an electronic movement or module, (c) an electromechanical movement or electromechanical module, (d) a movement or module with an electronic quartz oscillator as clock generator, whose frequency is kept by an oscillating quartz crystal, or (e) a movement or module with a linear encoder.

7. The wearable computer according to claim 5,
wherein the separate clock further comprises:
a rechargeable electric energy storage device for providing electric power to the separate clock.

8. The wearable computer according to claim 1,
wherein the display device is a transparent display device.

9. The wearable computer according to claim 1,
wherein the display device is a touch screen.

10. The wearable computer according to claim 1,
wherein the housing of the wearable computer further comprises:
at least one touch-sensitive sensor.

11. The wearable computer according to claim 1, further comprising:
at least one contactless sensor.

12. The wearable computer according to claim 11, further comprising:
wherein at least one contactless sensor is a position detecting and motion tracking sensor, and configured to track the movement of the wearable computer.

13. The wearable computer according to claim 11,
wherein at least one contactless sensor is configured to capture information about the surrounding environment.

14. The wearable computer according to claim 11,
wherein at least one contactless sensor is a camera.

15. The wearable computer according to claim 1, further comprising:
at least one microphone.

16. The wearable computer according to claim 1, further comprising:
a contact-based connection to an external power supply.

17. The wearable computer according to claim 1, further comprising:
a wireless charging module being electrically coupled to at least one electrical energy storage device, and configured to wirelessly collect external energy for charging one or more electrical energy storage device.

18. The wearable computer according to claim 17, wherein the wireless charging module comprises:
a receiving coil being configured to collect wireless electromagnetic energy emitted by a transmitting coil of an external power source; and
a conversion module being configured to convert said collected wireless electromagnetic energy into electric power having a predetermined voltage for charging at least one electrical energy storage device.

19. The wearable computer according to claim 1, further comprising:
a wireless communication interface device being configured to transmit and receive electromagnetic radiation, and to connect with other electrically operated devices,
wherein said wireless communication interface device is connected to the electronic module.

20. The wearable computer according to claim 1, further comprising:
a strap being mounted on the housing of the wearable computer.
